(19) United States
(12) Patent Application Publication
(10) Pub. No.: US 2010/0328549 A1
(43) Pub. Date: Dec. 30, 2010

(54) PROJECTION ELECTRONIC APPARATUS

(75) Inventors: Chang Ying Wu, Taipei City (TW); Fu Jun Yang, Taipei County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: MICRO-STAR INTERNATIONA'L CO., LTD., Taipei County (TW)

(21) Appl. No.: 12/571,021

(22) Filed: Sep. 30, 2009

(30) Foreign Application Priority Data
Jun. 24, 2009 (TW) 098211394

(51) Int. Cl. H04N 9/31; G06F 3/02

(52) U.S. Cl. 348/744; 345/168; 348/E09.025

(57) ABSTRACT

A projection electronic apparatus is presented. A movable keyboard component is disposed on a host of the electronic apparatus, and a projection component is disposed on the host. When the keyboard component is moved out from the host, a projection ray from the projection component is projected on a screen board outside the host, so as to display a projected screen picture. In addition, the screen board may also be pivoted to the host. When the screen board is opened from the host, the keyboard component is moved out from the host, and the projection ray from the projection component is projected on the screen board, so as to display a screen picture having a maximum scope.

### CROSS-REFERENCE TO RELATED APPLICATIONS

This non-provisional application claims priority under 35 U.S.C. §119(a) on Patent Application No(s). 098211394 filed in Taiwan, R.O.C. on Jun. 24, 2009, the entire contents of which are hereby incorporated by reference.

### BACKGROUND OF THE INVENTION

1. Field of the Invention

The present invention relates to an electronic apparatus, and more particularly to a projection electronic apparatus displaying a picture on a screen by projection.

2. Related Art

Along with the vigorous development of information technology, portable electronic apparatuses, such as notebook personal computers (PCs), mobile phones, personal digital assistants (PDAs), and other information electronic products, are increasingly popularized in life. The common portable electronic apparatus, for example, the notebook computer, usually comprises a host and a liquid crystal display (LCD). The host is used to receive related hardware equipment, and information processed by the hardware equipment is displayed on the LCD. Usually, a rotating shaft of the LCD is pivoted to the host, such that the LCD may be opened or closed on the host, for users to view the LCD and perform related operations.

However, recently the LCD of the notebook computer still has a problem of brightness attenuation after being used for a long time, or the liquid crystal glass tends to break after being impacted, and because of the disposition of the LCD, the price of the notebook computer is high.

Further, the micro projection technique has become much more mature recently, and in the related conventional art, the LCD of the notebook computer is replaced by a projection method, so as to lower the entire cost and entire weight of the notebook computer. Patent applications such as U.S. Pat. No. 6,806,850 and U.S. Pat. No. 5,483,250 respectively disclosed a micro projection technique of applying the micro projection to a notebook computer. In U.S. Pat. No. 5,483,250, a projection display system for a notebook computer is described, but the technique has a problem of a too short distance between a projection lens and a projection screen. When the distance between the projection lens and the projection screen is too short, an area scope of a projected picture from the projection lens is limited, such that the projection screen cannot display a projected picture having a maximum area scope. In another conventional art, for example, in U.S. Pat. No. 6,806,850, a portable electronic apparatus having a projection screen is described, in which a projection lens is moved to a height by using a link lever, so as to project a projection ray on the screen. However, for a structural design, the projection lens has to be moved between the user and the projection screen, so the projection lens shields the line of sight of the user, and the user cannot view the complete projected picture.

### SUMMARY OF THE INVENTION

Accordingly, it is known from the conventional art that if a micro projection technique is applied to a notebook computer, it is necessary to overcome a problem that a projection ray is shielded when a user operates a keyboard, and whether a scope of a projected picture affected by a projection distance is limited or not should be taken into consideration, such that the conventional art is difficult to be realized on practical application. In view of the above problem, the present invention is a preferred design of integrating the notebook computer and the micro projection technique, so as to solve a problem that the projection ray is interfered when the keyboard is operated. Moreover, in the present invention, a projection lens is disposed on an optimal position of the notebook computer, thus obtaining a projected picture having a maximum scope.

In an embodiment, the present invention provides a projection electronic apparatus, which comprises a host, a projection component, a keyboard component, and a screen board. The projection component is disposed on the host. The keyboard component is moveably disposed on the host, and has an operating position of moving out of the host and an accommodating position of moving in the host. The screen board is pivoted to the host and covers the keyboard component. When the screen board is opened relative to the host, the keyboard component is actuated to move out to the operating position outside the host, and the projection component is moved to a projection position and emits a projection ray to the screen board, thus displaying a projected screen picture on the screen board.

In another embodiment, the present invention further provides a projection electronic apparatus used to project a projection ray to a screen board. The projection electronic apparatus comprises a host, a projection component, and a keyboard component. The projection component is disposed on the host. The keyboard component is moveably disposed on the host, and has an operating position of moving out of the host and an accommodating position of moving in the host. When the keyboard component is moved out to the operating position outside the host, the projection component emits a projection ray to the screen board outside the host, thus displaying a projected screen picture on the screen board.

The present invention has the following efficacies. The projected picture having the maximum scope is obtained, and the problem that the projection ray is interfered when the keyboard is operated is solved. In a first embodiment, the projection component and the screen board are respectively disposed on two opposite side edges of the host, so as to obtain an optimal projection distance on the host. In order to prevent the projection ray from the projection component from being interfered when the keyboard component is operated, the keyboard component may be moved out. In this manner, the projection component projects the projection ray to the screen board with the optimal projection distance, and the projected picture having the maximum scope is displayed on the screen board. In a second embodiment, when being used, the keyboard component only needs to be move out from the host, and the projection component projects the projection ray to the screen board out of the host. When not being used, the keyboard component may be accommodated in the host, such that efficacies of accommodating and carrying the keyboard component and the host are achieved.

### BRIEF DESCRIPTION OF THE DRAWINGS

The present invention will become more fully understood from the detailed description given herein below for illustration only, and thus are not limitative of the present invention, and wherein:

FIG. 1 is a schematic exploded view of a portable electronic apparatus according to an embodiment of the present invention;

FIG. 2 is a schematic outside view of the portable electronic apparatus according to an embodiment of the present invention;

FIGS. 3A and 3B are schematic views of moving a projection component according to an embodiment of the present invention;

FIGS. 4A and 4B are schematic views of moving the projection component according to another embodiment of the present invention;

FIGS. 5A and 5B are schematic views of an action of moving a keyboard component out of a host according to an embodiment of the present invention;

FIGS. 6A and 6B are schematic views of the action of moving the keyboard component out of the host according to another embodiment of the present invention;

FIGS. 7A and 7B are schematic views of the action of moving the keyboard component out of the host according to further another embodiment of the present invention;

FIG. 8 is a schematic view of the action of moving the keyboard component out of the host according to still another embodiment of the present invention;

FIG. 9 is a schematic outside view of the portable electronic apparatus according to another embodiment of the present invention;

FIG. 10 is a schematic outside view of the portable electronic apparatus according to further another embodiment of the present invention;

FIG. 11 is a schematic exploded view of the portable electronic apparatus according to still another embodiment of the present invention; and

FIG. 12 is a schematic outside view of the portable electronic apparatus according to still another embodiment of the present invention.

### DETAILED DESCRIPTION OF THE INVENTION

In a projection electronic apparatus according to the present invention, a portable electronic apparatus comprises, is not limited to, a notebook computer, a tablet personal computer (PC), an ultra mobile PC (UMPC), or other portable electronic apparatuses having a cover lift structure. However, in embodiments of the present invention as follows, the notebook computer is set as an example. Definitely, application products and scope of the present invention are not limited to the embodiments as follows.

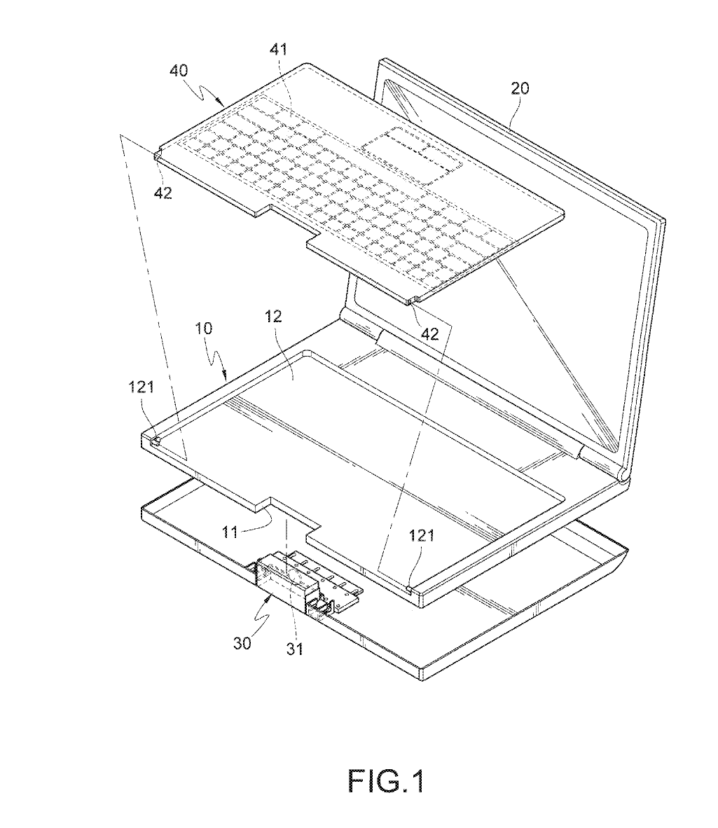

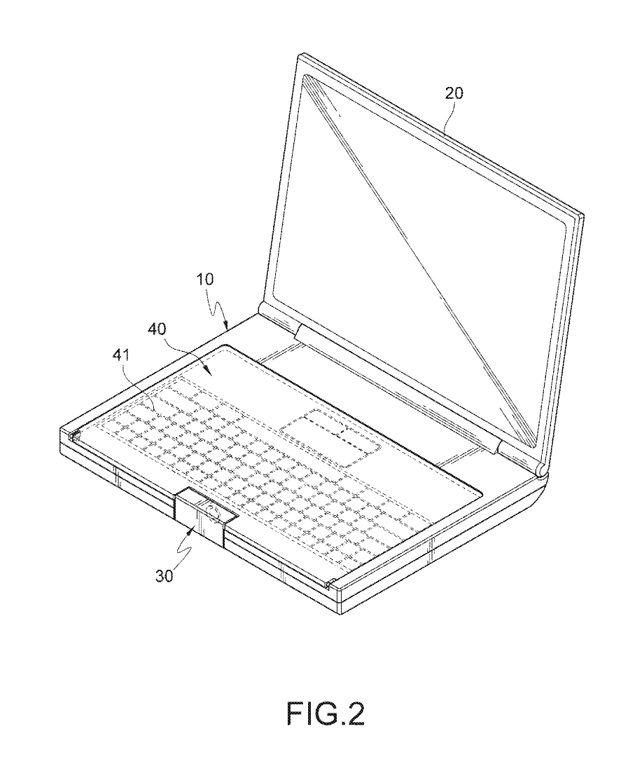

Referring to FIGS. 1 and 2, FIG. 1 is a schematic exploded view of the portable electronic apparatus according to an embodiment of the present invention, and FIG. 2 is a schematic outside view of the portable electronic apparatus according to an embodiment of the present invention.

The projection electronic apparatus according to the present invention approximately comprises a host 10, a screen board 20, a projection component 30, and a keyboard component 40. The host 10 receives a functional circuit device (not shown) such as a main board, a microprocessor, a memory, a hard disk, and other functional electronic devices, which belongs to the prior art and is not repeated herein.

The screen board 20 is pivoted to a rear side edge of the host 10 through a rotating shaft structure, such that the screen board 20 performs a rotating movement on the host 10 to open or close.

The projection component 30 is disposed on a front side edge of the host 10. Particularly, a receiving slot 11 is opened on the front side edge of the host 10, and the projection component 30 is moveably disposed in the receiving slot 11. Therefore, in the embodiments of the present invention as follows, two shifting mechanisms for enabling the projection component 30 to move out from the receiving slot 11 or to move in the receiving slot 11 are described below, but the present invention is not limited herein.

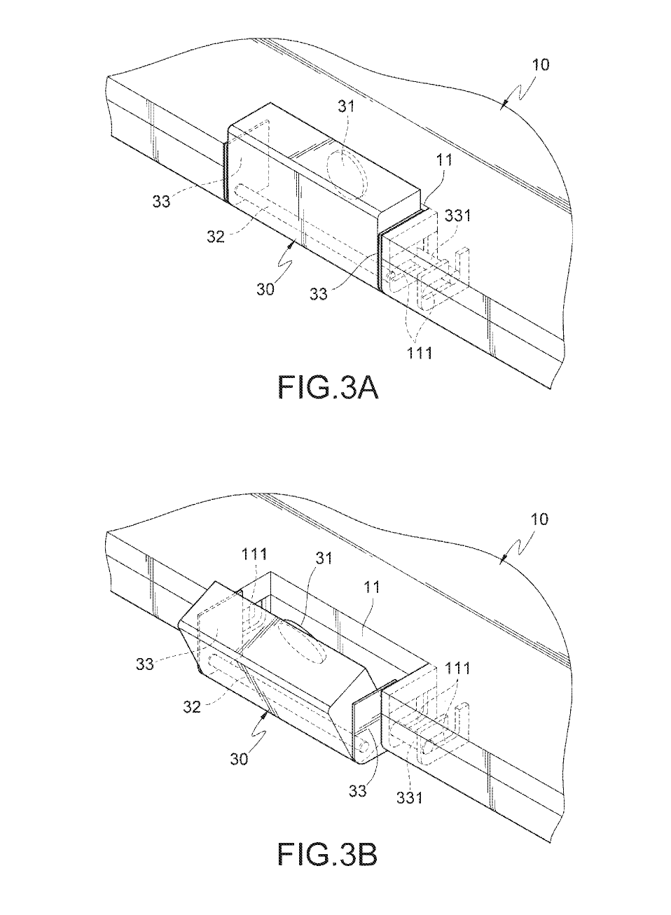

FIGS. 3A and 3B are schematic views of moving the projection component according to an embodiment of the present invention. Referring to FIGS. 3A and 3B, a sliding slot 111 is respectively disposed on inner side walls of two opposite sides of the receiving slot 11, and the two sliding slots 111 are respectively opened on the inner side walls of the receiving slot 11 along a horizontal direction. The projection component 30 is disposed in the receiving slot 11, and an electronic circuit having a projection function and related electronic devices (not shown) are disposed in the projection component 30. Further, a projection lens 31 is disposed on a lateral side of the projection component 30, such that the projection lens 31 is electrically connected to the electronic circuit and the devices disposed in the projection component 30.

Further, a shaft lever 32 is respectively raised on two opposite side edges of the projection component 30, and the two shaft levers 32 are respectively pivoted to a slide rail 33. A sliding block 331 is respectively disposed on a lateral side of the two slide rails 33, such that the sliding block 331 is correspondingly embedded in the sliding slot 111. Therefore, through the design of a sliding structure of the slide rail 33, the projection component 30 performs a shifting movement along the horizontal direction. Therefore, the projection component 30 has a projection position of moving out of the host 10 (referring to FIG. 3B) and an accepting position of being accommodated in the host 10 (referring to FIG. 3A).

In this manner, a user may pull the projection component 30 from the receiving slot 11, and moves the projection component 30 from the accepting position to the projection position. Then, the projection component 30 is rotated to an angle, such that a projection ray emitted from the projection lens 31 is irradiated on the screen board 20, so as to form a projected screen picture on the screen board 20.

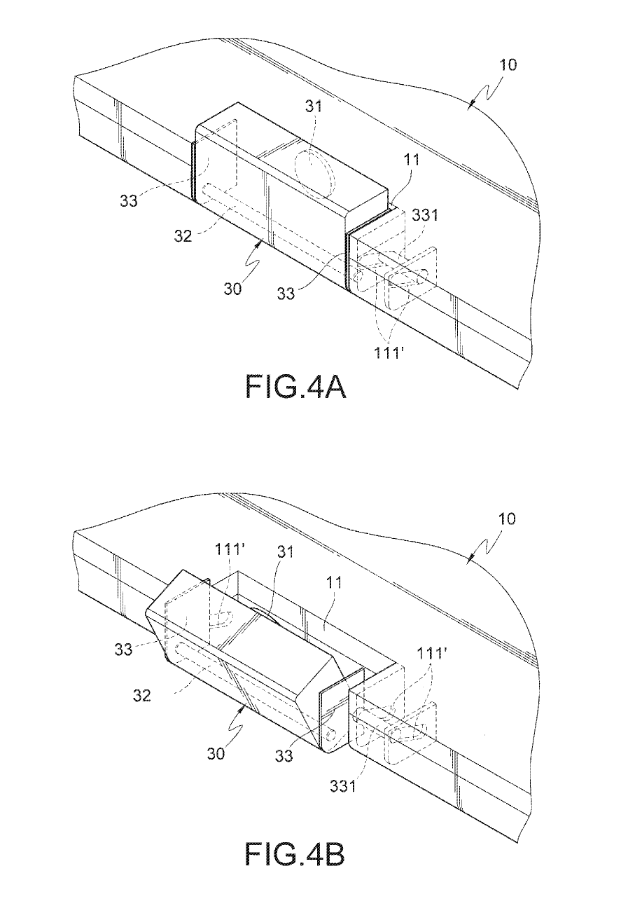

FIGS. 4A and 4B are schematic views of moving the projection component according to another embodiment of the present invention. Referring to FIGS. 4A and 4B, the implementation manner thereof is approximately the same as that of the above embodiment, and only differences are described as follows. A sliding slot 111′ is respectively disposed on the inner side walls of the two opposite sides of the receiving slot 11, and the two sliding slots 111′ are opened on the inner side walls of the receiving slot 11 along an inclined direction. The referred inclined direction is increasingly inclined upwards from the inside of the receiving slot 11 and is extended to an opening. In this manner, when the user pulls the projection component 30 from the receiving slot 11, through a structural design of the slide rail 33 and the inclined sliding slot 111′, the projection component 30 performs an inclined shifting movement, so as to be moved from the accepting position to the projection position. Then, the projection component 30 is rotated to an angle, such that a projection ray emitted from the projection lens 31 is irradiated on the screen board 20, so as to form a projected screen picture on the screen board 20.

Further, the keyboard component 40 is disposed on the host 10, and the keyboard component 40 is composed of a plurality of arranged press keys 41, so as to form an operating scope of a specific area through the press keys 41. Particularly, an accommodating slot 12 is opened on the host 10, and a size of the accommodating slot 12 matches a size of the keyboard component 40, such that the keyboard component 40 is just received in the accommodating slot 12. It should be particularly noted that the keyboard component 40 is moveably disposed in the accommodating slot 12 of the host 10, such that the keyboard component 40 has an operating position of moving out of the host 10 and an accommodating position of moving in the host 10. Therefore, in the embodiments of the present invention as follows, four mechanisms for enabling the keyboard component 40 to move between the operating position and the accommodating position are described below, but the present invention is not limited here.

Referring to FIGS. 1 and 2, the keyboard component 40 is pivoted to the accommodating slot 12 through the rotating shaft structure. Particularly, a shaft hole 42 is respectively disposed on two opposite sides of the keyboard component 40, and a shaft 121 is respectively disposed on the accommodating slot 12 corresponding to the shaft hole 42, such that the shaft 121 is pivoted to the shaft hole 42. In this manner, through the structure of pivoted shaft hole 42 and shaft 121, the keyboard component 40 performs a rotational shifting movement on the host 10.

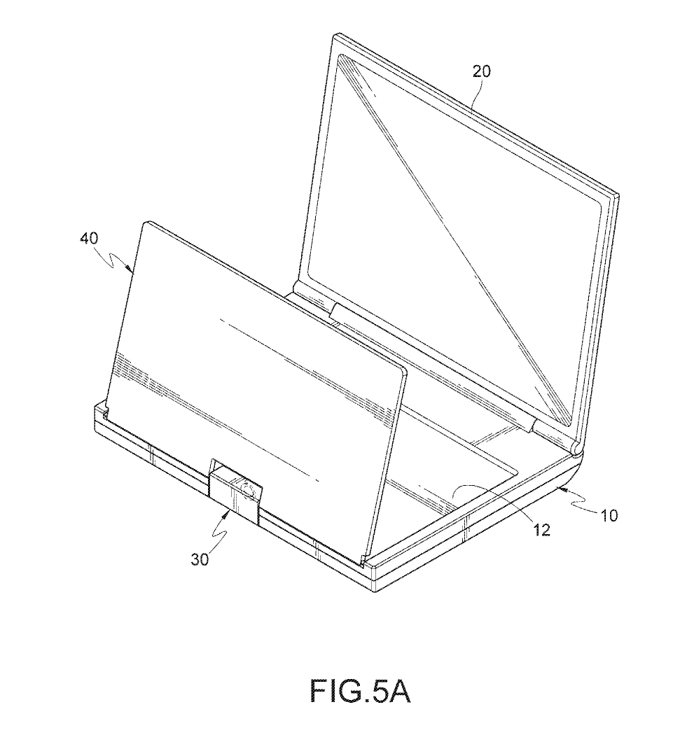

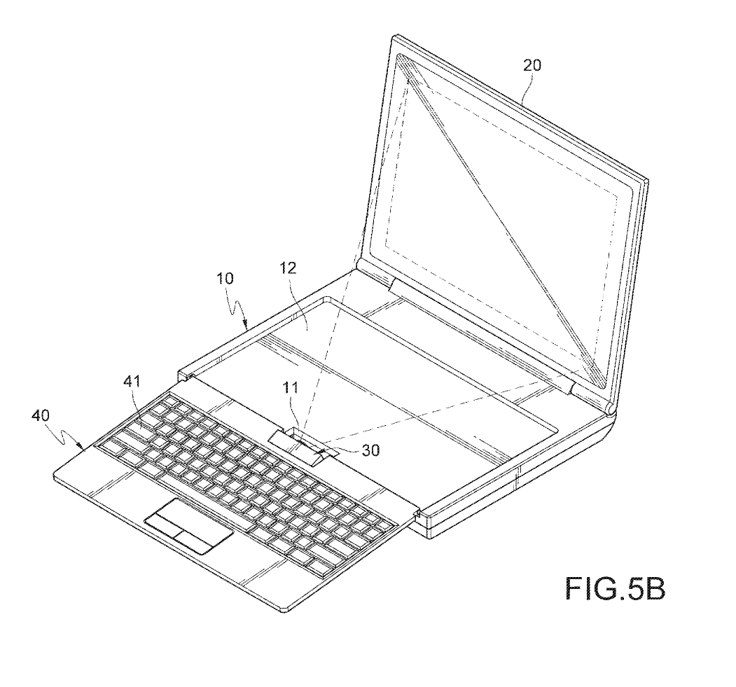

FIGS. 5A and 5B are schematic views of an action of moving the keyboard component out of the host according to an embodiment of the present invention. Referring to FIGS. 5A and 5B, when the user intends to operate the projection electronic apparatus of the present invention, the user only needs to open the screen board 20 from the host 10. Next, the user rotationally pulls the keyboard component 40 to move out from the accommodating slot 12 to the operating position outside the host 10. In other words, the plurality of press keys 41 disposed on a front side of the keyboard component 40 is received facing the accommodating slot 12. When the keyboard component 40 is rotated to open, the plurality of press keys 41 disposed on the front side of the keyboard component 40 faces the user, such that the user presses the plurality of press keys 41 to input instruction signals. Then, the projection component 30 is pulled to a projection position (a moving structure of the projection component is as shown in FIGS. 3A and 3B or FIGS. 4A and 4B), and the projection component 30 is rotated to an angle, such that a projection ray emitted from the projection lens 31 is irradiated on a screen board 20, so as to display a projected screen picture on the screen board 20.

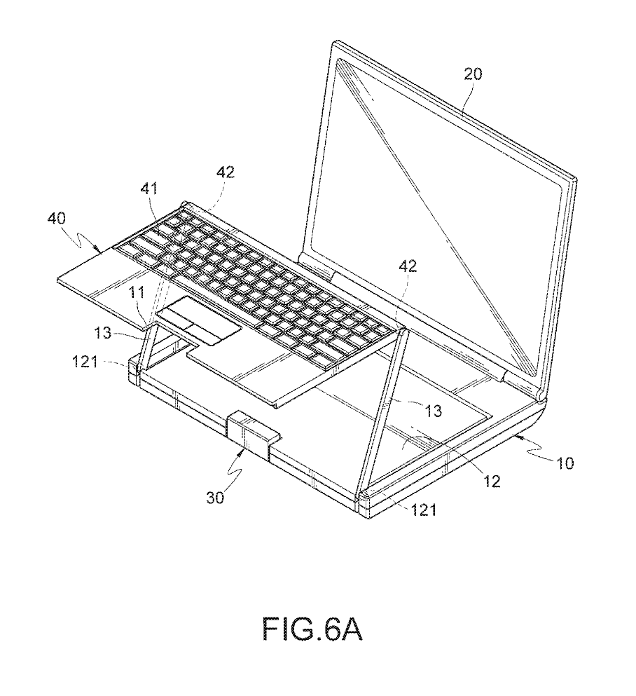

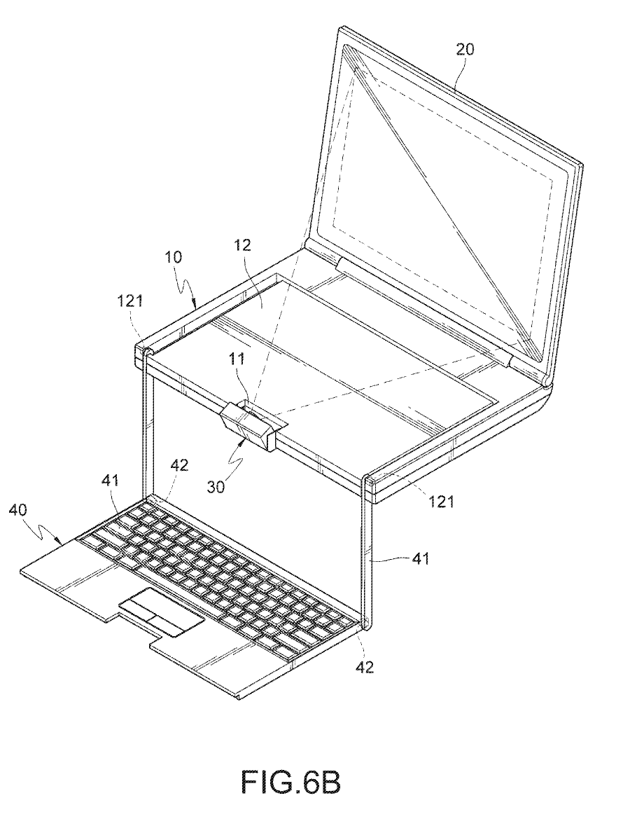

FIGS. 6A and 6B are schematic views of the action of moving the keyboard component out of the host according to another embodiment of the present invention. Referring to FIGS. 6A and 6B, the keyboard component 40 is pivoted to the accommodating slot 12 through a link lever structure. Particularly, a link lever 13 is respectively disposed on two opposite sides of the accommodating slot 12, such that one end of each of the link levers 13 is respectively pivoted to the shaft 121 of the accommodating slot 12, and the other end of each of the link levers 13 is respectively pivoted to the shaft hole 42 of the keyboard component 40. In this manner, through the design of the pivoting structure of the link lever 13, the keyboard component 40 performs a shifting movement on the host 10 realized by the rotation of the link levers. When the user intends to operate the projection electronic apparatus of present invention, the user only needs to open the screen board 20 from the host 10, and enables the link levers 13 to drive the keyboard component 40 to move out from the accommodating slot 12 to the operating position outside the host 10. Next, the projection component 30 is pulled to the projection position (the moving structure of the projection component is as shown in FIGS. 3A and 3B or FIGS. 4A and 4B), and the projection component 30 is rotated to an angle, such that a projection ray emitted from the projection lens 31 is irradiated on the screen board 20, so as to display a projected screen picture on the screen board 20.

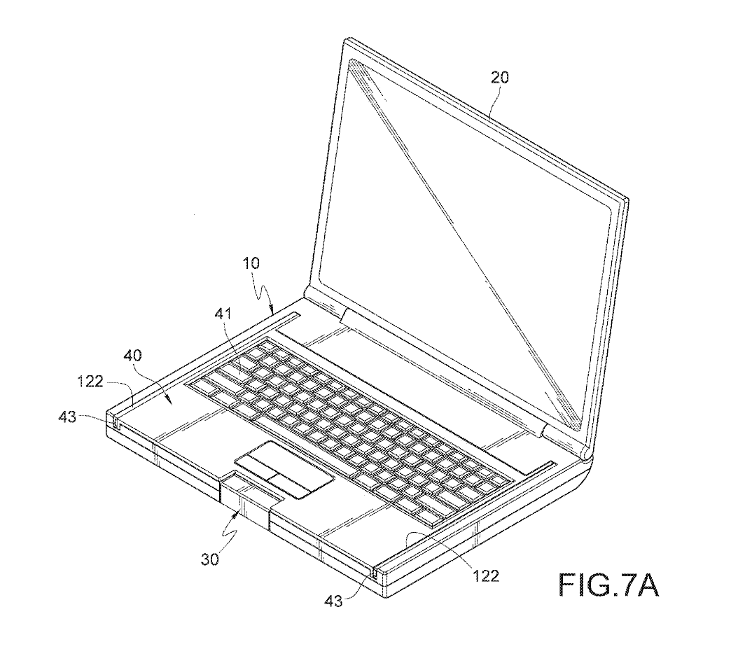

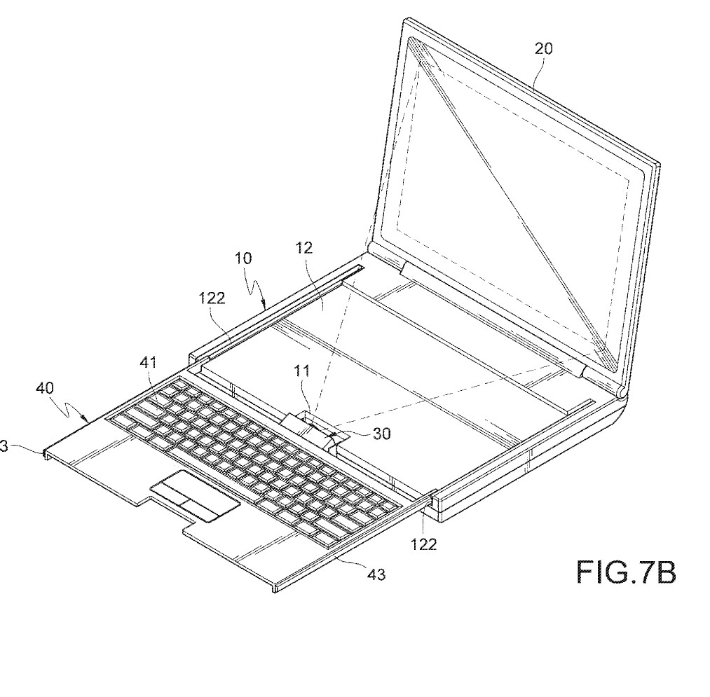

FIGS. 7A and 7B are schematic views of the action of moving the keyboard component out of the host according to further another embodiment of the present invention. Referring to FIGS. 7A and 7B, the keyboard component 40 is disposed in the accommodating slot 12 through a slide rail structure. Particularly, a rail slot 122 is respectively disposed on the two opposite sides of the accommodating slot 12, a slide rail 43 is respectively disposed on the two opposite side edges of the keyboard component 40, and the slide rail 43 is embedded in the rail slot 122. In this manner, through a design of the sliding structure of the slide rail 43 in the slide rail 43, the keyboard component 40 performs a to-and-fro shifting movement relative to the host 10.

When the user intends to operate the projection electronic apparatus of present invention, the user only needs to open the screen board 20 from the host 10, and pulls the keyboard component 40 from the accommodating slot 12 to the operating position outside the host 10. Next, the projection component 30 is pulled to a projection position (the moving structure of the projection component is as shown in FIGS. 3A and 3B or FIGS. 4A and 4B), and the projection component 30 is rotated to an angle, such that a projection ray emitted from the projection lens 31 is irradiated on the screen board 20, so as to display a projected screen picture on the screen board 20.

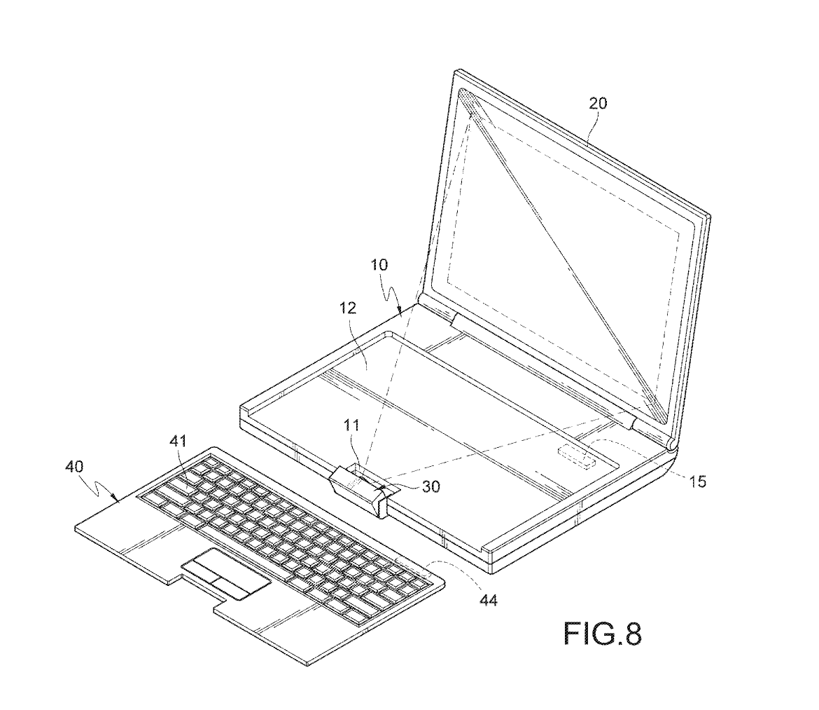

FIG. 8 is a schematic view of the action of moving the keyboard component out of the host according to still another embodiment of the present invention. Referring to FIG. 8, the keyboard component 40 is a wireless keyboard. A first wireless transmitter 15 is disposed in the host 10, and a second wireless transmitter 44 is disposed in the keyboard component 40, such that the first wireless transmitter 15 and the second wireless transmitter 44 perform a signal transmission in a Bluetooth transmission manner or an infrared transmission manner.

When the screen board 20 is opened from the host 10, the keyboard component 40 is pulled from the accommodating slot 12 to the operating position outside the host 10. Next, the projection component 30 is pulled to a projection position (the moving structure of the projection component is as shown in FIGS. 3A and 3B or FIGS. 4A and 4B), and the projection component 30 is rotated to an angle, such that a projection ray emitted from the projection lens 31 is irradiated on the screen board 20, so as to display a projected screen picture on the screen board 20.

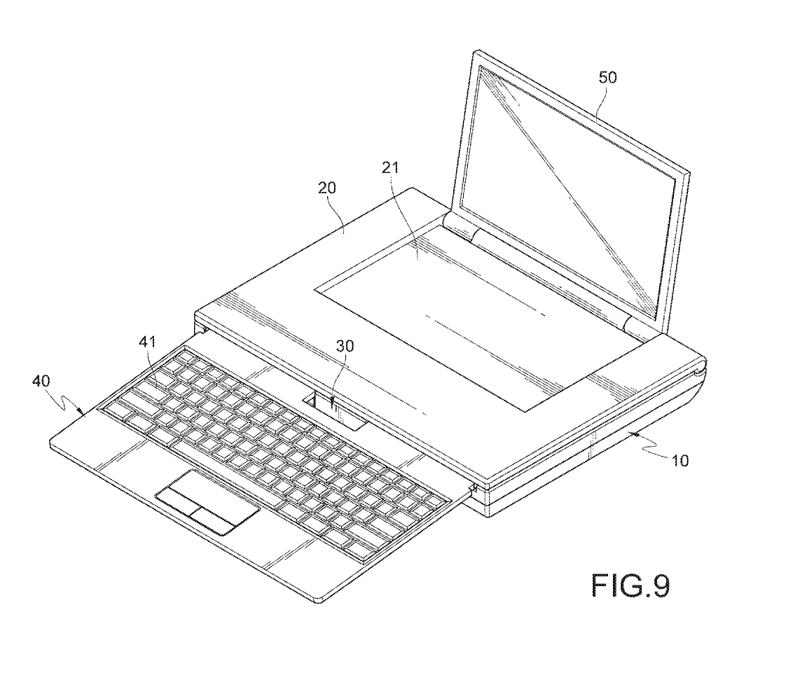

FIG. 9 is a schematic outside view of the portable electronic apparatus according to another embodiment of the present invention. Referring to FIG. 9, the portable electronic apparatus comprises a screen panel 50 disposed on a lateral side of the screen board 20. Particularly, a groove 21 is opened on an outer surface of the screen board 20, and the screen panel 50 is pivoted to the screen board 20 through a rotating shaft structure, such that the screen panel 50 is pivotally rotated between an attaching position flatly attached to the groove 21 and an upstanding position spreading on the screen board 20. In this manner, when moving the keyboard component 40 to the operating position outside the host 10, the user may close the screen board 20 on the host 10 again, and rotate the screen panel 50 from the attaching position to the upstanding position. The user then operates the press keys 41 on the keyboard component 40, and views the screen picture displayed on the screen panel 50.

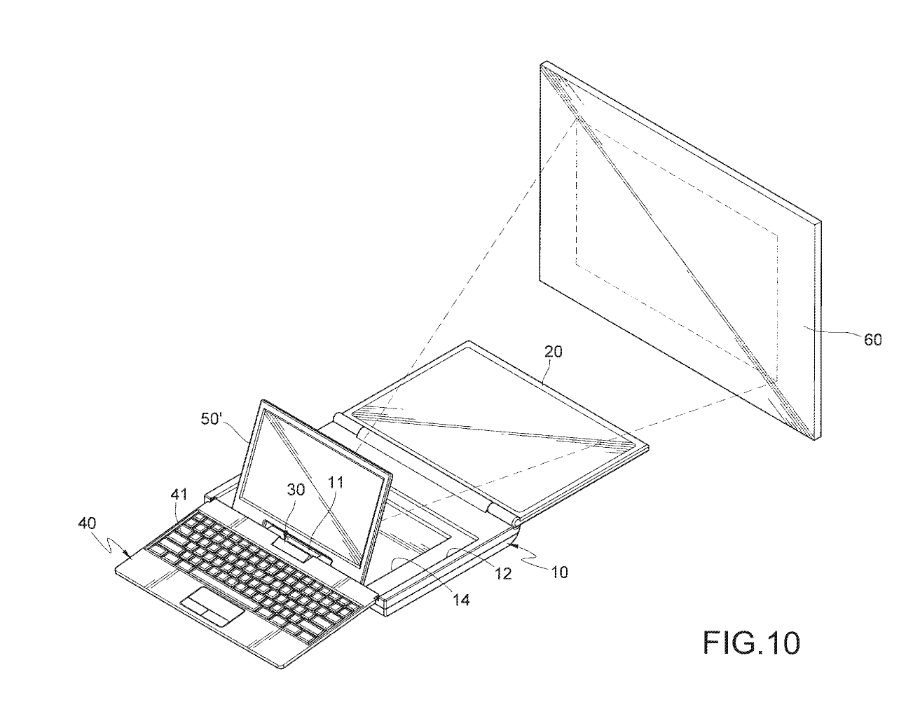

FIG. 10 is a schematic outside view of the portable electronic apparatus according to further another embodiment of the present invention. Referring to FIG. 10, the portable electronic apparatus comprises a screen panel 50′ disposed in the host 10. A groove 14 is opened in the accommodating slot 12 of the host 10, and the screen panel 50′ is pivoted to the keyboard component 40 through a rotating shaft structure, such that the screen panel 50′ is pivotally rotated between an attaching position flatly attached to the groove 14 and an upstanding position spreading on the keyboard component 40.

After opening the screen board 20, the user moves the keyboard component 40 out from the accommodating slot 12 to the operating position out of the host 10, and rotates the screen panel 50′ from the attaching position to the upstanding position. Then, the user pulls the projection component 30 to a projection position, and rotates the projection component 30 to an angle, such that a projection ray emitted from the projection lens 31 is irradiated on the distal projection screen 60. In this manner, the user may operate the press keys 41 on the keyboard component 40, and view the screen picture displayed on the screen panel 50′. The projection component 30 emits a projection ray to form a projected picture on the distal projection screen 60 corresponding to what is displayed on the screen panel 50′, such that other peoples are able to synchronously view the projected picture of the screen.

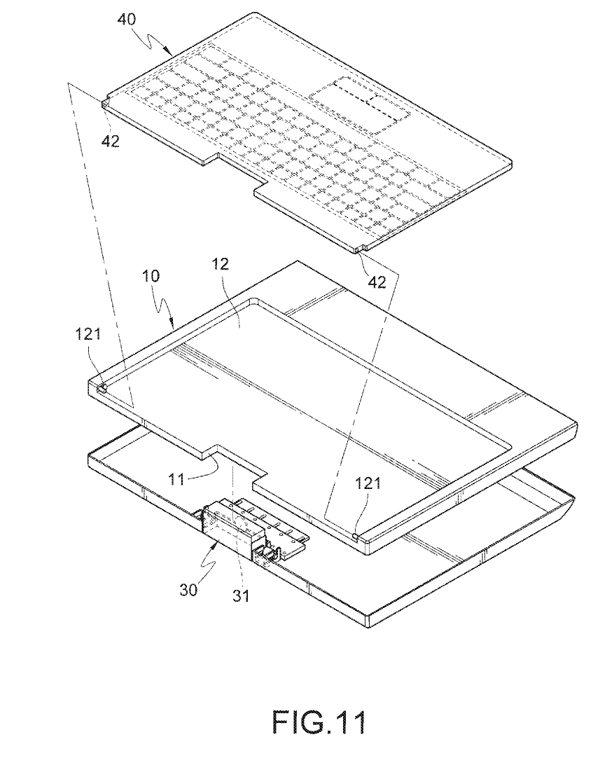

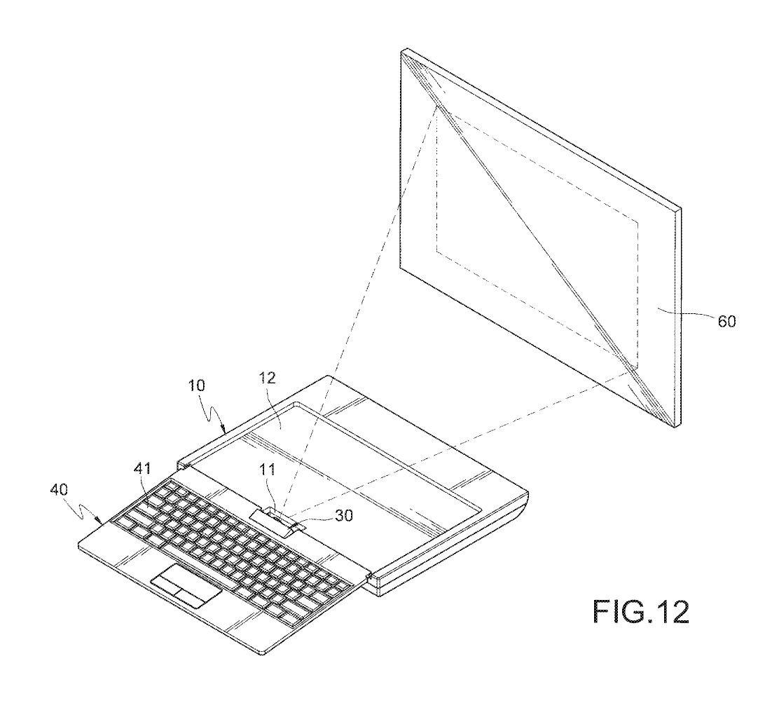

FIGS. 11 and 12 are a schematic exploded view and a schematic outside view of the portable electronic apparatus according to still another embodiment of the present invention. The projection electronic apparatus according to the present invention approximately comprises a host 10, a projection component 30, and a keyboard component 40. The host 10 receives a functional circuit device (not shown), for example, the main board, the microprocessor, the memory, the hard disk, and other functional electronic devices, which belong to existing techniques and are not repeated herein.

The projection component 30 is disposed on the front side edge of the host 10. Particularly, a receiving slot 11 is opened on the front side edge of the host 10, and the projection component 30 is moveably disposed in the receiving slot 11. Therefore, in this embodiment, two shifting mechanisms enabling the projection component 30 to move out from the receiving slot 11 or move in the receiving slot 11 are described (see FIGS. 3A and 3B or FIGS. 4A and 4B), but the present invention is not limited herein. The keyboard component 40 is disposed on the host 10, and the keyboard component 40 is composed of a plurality of arranged press keys 41, so as to form an operating scope of a specific area through the press keys 41. Particularly, an accommodating slot 12 is opened on the host 10, and a size of the accommodating slot 12 matches a size of the keyboard component 40, such that the keyboard component 40 is just received in the accommodating slot 12. It should be particularly noted that the keyboard component 40 is moveably disposed in the accommodating slot 12 of the host 10, such that the keyboard component 40 has an operating position of moving out of the host 10 and an accommodating position of moving in the host 10. Therefore, in this embodiment, the mechanisms as shown in FIGS. 5A to 8 for enabling the keyboard component 40 to move between the operating position and the accommodating position are described, but the present invention is not limited herein.

After the keyboard component 40 is moved out from the accommodating slot 12 to the operating position outside the host 10, the projection component 30 is pulled to the projection position, and the projection component 30 is rotated to an angle, such that a projection ray emitted from the projection lens 31 is irradiated on a distal projection screen 60. In this manner, the user may operate the press keys 41 on the keyboard component 40, and view the screen picture displayed on the projection screen 60.

What is claimed is:

1. A projection electronic apparatus, comprising:
a host;
a projection component, disposed on the host;
a keyboard component, moveably disposed on the host, and having an operating position of moving out of the host and an accommodating position of moving in the host; and
a screen board, pivoted to the host and covering the keyboard component, wherein when the screen board is opened relative to the host, the keyboard component is located in the operating position, and the projection component emits a projection ray to the screen board, so as to display a projected screen picture on the screen board.

2. The projection electronic apparatus according to claim 1, further comprising a receiving slot, opened on a side edge of the host, wherein a sliding slot is respectively disposed on two opposite sides of the receiving slot, and a slide rail is respectively disposed on the projection component corresponding to the sliding slot, the slide rail has a sliding block and is embedded in the sliding slot, such that the projection component has a projection position of moving out of the receiving slot and an accepting position of moving in the receiving slot.

3. The projection electronic apparatus according to claim 2, wherein the projection component further comprises a projection lens, and a shaft lever pivoted to the slide rail is respectively disposed on two opposite sides of the projection component, the projection component is rotated with the shaft lever, such that the projection lens is rotated to an angle and projects the projection ray on the screen board.

4. The projection electronic apparatus according to claim 1, further comprising an accommodating slot, opened on a surface of the host, wherein a shaft of the accommodating slot is pivoted to a shaft hole of the keyboard component, such that the keyboard component is rotated from the accommodating slot to the operating position outside the host or from the outside of the host to the accommodating position in the accommodating slot.

5. The projection electronic apparatus according to claim 1, further comprising an accommodating slot, opened on a surface of the host, wherein at least one link lever of the accommodating slot is pivoted to the keyboard component, such that the link lever drives the keyboard component to move out from the accommodating slot to the operating position outside the host or drives the keyboard component to move from the outside of the host to the accommodating position in the accommodating slot.

6. The projection electronic apparatus according to claim 1, further comprising an accommodating slot, opened on a surface of the host, wherein a rail slot is respectively disposed on two opposite sides of the accommodating slot, a slide rail is respectively disposed on two opposite side edges of the keyboard component, and the slide rail is embedded in the rail slot, such that the keyboard component slides out from the accommodating slot to the operating position outside the host or slides from the outside of the host to the accommodating position in the accommodating slot.

7. The projection electronic apparatus according to claim 1, further comprising a screen panel, pivoted to the screen board, wherein a groove is opened on an outer surface of the screen board, and the screen panel is pivotally rotated between an attaching position flatly attached to the groove and an upstanding position spreading on the screen board.

8. The projection electronic apparatus according to claim 1, further comprising a screen panel, pivoted to the keyboard component, wherein a groove is opened on a surface of the host, and the screen panel is pivotally rotated between an attaching position flatly attached to the groove and an upstanding position spreading on the keyboard component.

9. A projection electronic apparatus, used to project a projection ray to a screen board, comprising:
a host;
a projection component, disposed on the host; and
a keyboard component, moveably disposed on the host, and having an operating position of moving out of the host and an accommodating position of moving in the host, wherein when the keyboard component is located in the operating position, the projection component emits a projection ray to the screen board, so as to display a projected screen picture on the screen board.

10. The projection electronic apparatus according to claim 9, further comprising a receiving slot, opened on a side edge of the host, wherein a sliding slot is respectively disposed on two opposite sides of the receiving slot, and a slide rail is respectively disposed on the projection component corresponding to the sliding slot, the slide rail has a sliding block and is embedded in the sliding slot, such that the projection component has a projection position of moving out of the receiving slot and an accepting position of moving in the receiving slot.

11. The projection electronic apparatus according to claim 10, wherein the projection component further comprises a projection lens, and a shaft lever pivoted to the slide rail is respectively disposed on two opposite sides of the projection component, the projection component is rotated with the shaft lever, such that the projection lens is rotated to an angle and projects the projection ray on the screen board.

12. The projection electronic apparatus according to claim 9, further comprising an accommodating slot, opened on a surface of the host, wherein a shaft of the accommodating slot is pivoted to a shaft hole of the keyboard component, such that the keyboard component is rotated from the accommodating slot to the operating position outside the host or from the outside of the host to the accommodating position in the accommodating slot.

13. The projection electronic apparatus according to claim 9, further comprising an accommodating slot, opened on a surface of the host, wherein at least one link lever of the accommodating slot is pivoted to the keyboard component, such that the link lever drives the keyboard component to move out from the accommodating slot to the operating position outside the host or drives the keyboard component to move from the outside of the host to the accommodating position in the accommodating slot.

14. The projection electronic apparatus according to claim 9, further comprising an accommodating slot, opened on a surface of the host, wherein a rail slot is respectively disposed on two opposite sides of the accommodating slot, a slide rail is respectively disposed on two opposite side edges of the keyboard component, and the slide rail is embedded in the rail slot, such that the keyboard component slides out from the accommodating slot to the operating position outside the host or slides from the outside of the host to the accommodating position in the accommodating slot.
